(19) United States
(12) Patent Application Publication
(10) Pub. No.: US 2006/0239520 A1
(43) Pub. Date: Oct. 26, 2006

(54) System and method for detecting fibre tracts

(76) Inventors: Arianne Margarethe Corinne Van Muiswinkel, Eindhoven (NL); Ronaldus Frederik Johannes Holthuizen, Eindhoven (NL); Frank Gerardus Cornelis Hoogenraad, Eindhoven (NL)

Correspondence Address: PHILIPS INTELLECTUAL PROPERTY & STANDARDS, 595 MINER ROAD, CLEVELAND, OH, 44143, US

(21) Appl. No.: 10/553,304

(22) PCT Filed: Apr. 5, 2004
(86) PCT No.: PCT/IB04/50397

§ 371 Date: Oct. 14, 2005

(30) Foreign Application Priority Data
Apr. 14, 2003 (EP) 03100995.4

(51) Int. Cl. G06K 9/00

(52) U.S. Cl. 382/128

(57) ABSTRACT

The invention relates to a system for displaying fibre tracts of a human or animal, comprising memory means holding diffusion images of a region of interest of said human or animal, processing means connected to the memory means for deriving fibre tract data from the diffusion images, and display means for displaying the fibre tracts derived by the processing means wherein the processing means include a discriminator to select the fibre tract data to be displayed on the display means.

The invention relates to a system for detecting fibre tracts of a human or animal, comprising memory means for holding diffusion images of a region of interest of said human or animal, first processing means connected to the memory means for deriving fibre tract data from the diffusion images, and second processing means for processing the fibre tracts derived by the first processing means.

Such a system is known from JP-A-11-000320.

In this known system the first processing means deduce a highest direction of a diffusion coefficient with a pre-determined point as a starting point using a diffusion tensor at each point of the image and deducing the next point located at a position that is a pre-determined distance apart in that direction, and continuing this process with a deduced next point as the starting point for the next step. The display means of this system serve as the second processing means of the fibre tracks and merely display all points derived by this known method, resulting in an image which is considered to represent the nerve fibres that are actually present.

A problem with this known system is that the displayed information is not entirely accurate due to noise or other causes which results in the display of fibres that are spurious or otherwise of no interest.

In this connection it is remarked that the diffusion images are the result of indirect measurements such as obtained by magnetic resonance imaging.

Magnetic resonance imaging is known in the art in general. The application of magnetic resonance imaging for fibre tracking is known from WO-A-01/91639.

From this publication WO-A-01/91639 it is known to initiate fibre tracking by selecting a pixel from a diffusion tensor magnetic resonance image, to connect the pixels and to effect a judgement regarding termination of the pixel tracking, which in each direction is based upon the randomness of the fibre orientation of the adjacent pixels. The technology disclosed in this document suffers however from the same problem as JP-A-11-000320, i.e. the processing or display of spurious fibres.

The invention is aimed to resolve this problem.

According to the invention the system for detecting fibre tracts of a human or animal is characterized in that the first processing means includes a discriminator to select the fibre tract data to be processed by the second processing means. The second processing means can be used for several purposes, for instance to execute statistical analysis on the data, or to effect that the fibre tract data are displayed on display means.

By the application of the discriminator the validity of the fibre tract data can be vastly improved.

This can particularly be accomplished in a system which according to a preferred embodiment is characterized in that the discriminator prevents selecting fibre tract data that jointly represent a fibre tract or fibre tracts of less than a pre-determined length. The discriminator regards fibre tracts of less than the pre-determined length as being invalid. Such too short fibre tracts are considered to be spurious which consequently need not be available for further processing such as displaying.

In a further aspect of the invention the system is characterized in that the discriminator prevents selecting fibre tract data that jointly represent a bundle of fibre tracts of less than a pre-determined number of fibre tracts per surface area or per volume. This measure rules out the display of single erroneous tracts.

The invention is also embodied in a method of detecting fibre tracts of a human or animal in which diffusion image data of a region of interest of such human or animal are processed to derive fibre tract data that are thereafter further processed, for instance displayed.

The method of the invention is characterized in that further processing of the fibre tract data is restricted to such fibre tract data that jointly represent a fibre tract or fibre tracts that satisfy at least one predetermined criterion.

In a first preferred embodiment of the invention the method is characterized in that a first pre-determined criterion is selected to represent a minimum-length of the fibre tract or fibre tracts.

In a second preferred embodiment which may be combined with the first preferred embodiment, the method is characterized in that a second pre-determined criterion is selected to represent a minimum number of fibre tracts per surface area or volume that are part of a bundle of fibre tracts.

When indeed the first pre-determined criterion and the second pre-determined criterion are employed in combination, the method may automatically yield all fibre bundles in the tissue being examined. This tissue under examination may furthermore be compared to a standard data set in order to improve the reliability of the fibre tracking according to the invention.

Results of the invention are shown hereafter with reference to an exemplary embodiment of a system according to the invention, in which diffusion tensor magnetic resonance images are processed in order to obtain fibre tracts. The invention further relates to a computer programme as defined in claim 7. The computer programme of the invention may be downloaded into a system for detecting fibre tracks so as to enable the system to carry out the method of the invention. The computer programme may be supplied on a data carrier such as a CD-rom, or may be downloaded from a data network, such as the world-wide web.

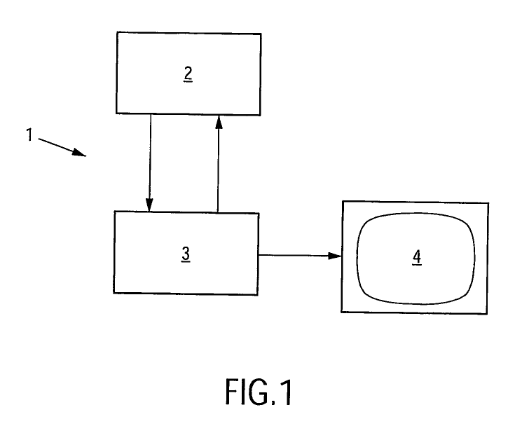

FIG. 1 shows the system according to the invention.

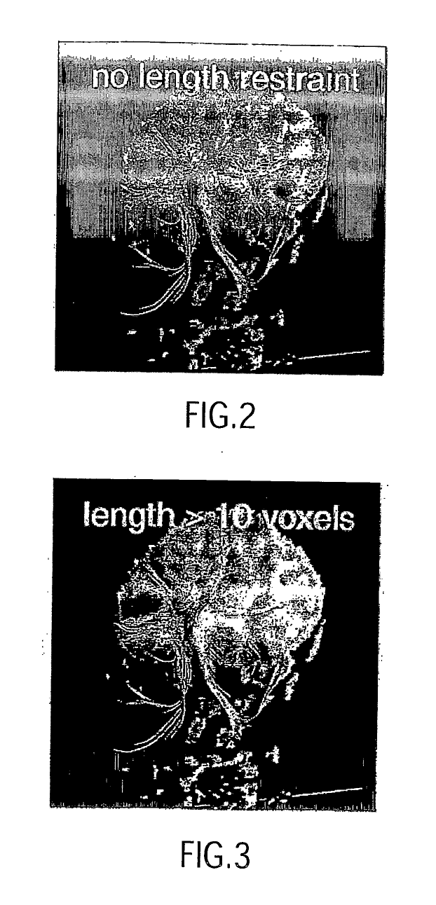

FIGS. 2 to 5 show some results obtained with the system according to the invention.

With reference to FIG. 1 the system according to the invention is indicated with reference number 1. This system for detecting fibre tracts of a human or animal comprises memory means (2) for holding diffusion images of a region of interest of said human or animal. The images can be derived for instance with magnetic resonance imaging which is known to the person skilled in the art and which requires therefore no further elucidation.

The memory means (2) are connected to first processing means (3) which operates on the diffusion images that are held in the memory means (2). The first processing means (3) are connected to second processing means, in this example display means (4) for displaying the fibre tracts that are derived from the diffusion images by the first processing means (3). To this end the first processing means (3) includes a discriminator to select the fibre tract data that are to be displayed on the display means (4). The results are comparatively shown in the following figures.

FIG. 2 shows the image visualised on the display when the discriminator is not employed.

FIGS. 3, 4 and 5 show the image being visualised on the display means when the discriminator is active to display only fibre tract data that represent a minimum-length of the fibre tract or fibre tracts to be displayed.

In FIG. 3 the minimum-length of the fibre tracts to be displayed amounts to 10 voxels.

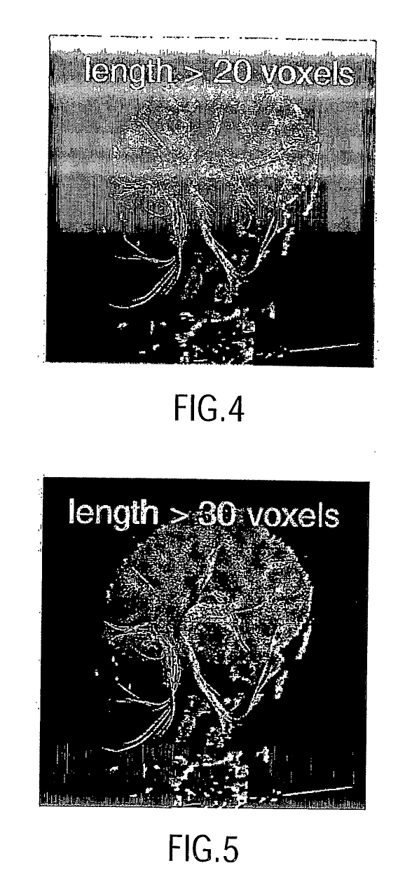

In FIG. 4 the said minimum-length amounts to 20 voxels whereas in FIG. 5 the said minimum-length amounts to 30 voxels.

As a result of the invention the display of undesired short fibres is prevented and the recognition of bundles of fibres can take place more easy.

1. System for detecting fibre tracts of a human or animal, comprising memory means for holding diffusion images of a region of interest of said human or animal, first processing means connected to the memory means for deriving fibre tract data from the diffusion images, and second processing means for processing the fibre tracts derived by the first processing means, wherein the first processing means includes a discriminator to select the fibre tract data to be processed by the second processing means.

2. System according to claim 1, wherein the discriminator prevents selecting fibre tract data that jointly represent a fibre tract or fibre tracts of less than a pre-determined length.

3. System according to claim 1, wherein the discriminator prevents selecting fibre tract data that jointly represent a bundle of fibre tracts of less than a pre-determined number of fibre tracts per surface area or per volume.

4. Method of detecting fibre tracts of a human or animal comprising the steps of
processing diffusion image data of a region of interest of said human or animal to derive fibre tract data;
processing the fibre tract data wherein processing the fibre tract data is restricted to such fibre tract data that jointly represent a fibre tract or fibre tracts that satisfy at least one pre-determined criterion.

5. Method according to claim 4, wherein a first pre-determined criterion is selected to represent a minimum-length of the fibre tract or fibre tracts.

6. Method according to claim 4, wherein a second pre-determined criterion is selected to represent a minimum number of fibre tracts per surface area or volume that are part of a bundle of fibre tracts to be processed.

7. Computer programme for detecting fibre tracts of a human or animal comprising instructions for
processing diffusion image data of a region of interest of said human or animal to derive fibre tract data;
processing the fibre tract data wherein processing the fibre tract data is restricted to such fibre tract data that jointly represent a fibre tract or fibre tracts that satisfy at least one pre-determined criterion.
